(19) United States
(12) Patent Application Publication
(10) Pub. No.: US 2021/0150195 A1
(43) Pub. Date: May 20, 2021

(54) CLOTHING INFORMATION ACQUISITION SYSTEM AND CLOTHING INFORMATION ACQUISITION METHOD

(71) Applicant: TOYOTA JIDOSHA KABUSHIKI KAISHA, Toyota-shi (JP)

(72) Inventors: Hiroyuki BANDAI, Nagakute-shi (JP); Keiko SUZUKI, Tokyo (JP); Chihiro INABA, Tokyo (JP); Toshiyuki HAGIYA, Shiki-shi (JP)

(73) Assignee: TOYOTA JIDOSHA KABUSHIKI KAISHA, Toyota-shi (JP)

(21) Appl. No.: 17/001,987

(22) Filed: Aug. 25, 2020

(30) Foreign Application Priority Data
Nov. 15, 2019 (JP) 2019-207387

(51) Int. Cl. G06K 9/00; G06K 9/46; G06Q 30/06

(52) U.S. Cl. CPC G06K 9/00362; G06K 9/00791; B60R 2011/0003; G06Q 30/0631; G06Q 30/0643; G06K 9/46

(57) ABSTRACT

A clothing information acquisition device includes an image acquisition unit that acquires a captured image obtained by capturing an image of the outside of a vehicle by an in-vehicle camera and location information on a location at which the image is captured, a specifying unit that specifies clothing information of a person included in the captured image, and a storage unit that stores the specified clothing information in association with the location information.

### CROSS-REFERENCE TO RELATED APPLICATION

This application claims priority to Japanese Patent Application No. 2019-207387 filed on Nov. 15, 2019, incorporated herein by reference in its entirety.

### BACKGROUND

### 1. Technical Field

The present disclosure relates to technology for acquiring clothing information of a person included in a captured image using an image captured by an in-vehicle camera.

### 2. Description of Related Art

Japanese Unexamined Patent Application Publication No. 2010-15565 (JP 2010-15565 A) discloses a social network application that receives an image of a user's outfit, extracts fashion preferences of the user from the outfit of the user, and groups a plurality of users having similar fashion preferences. This social network application recommends outfit-related items based on the user's fashion preferences.

### SUMMARY

The disclosure disclosed in JP 2010-15565 A is characterized in that it is preferable that data on outfit-related items recommended to a user can reflect the outfits of actual peoples in a city, and it is also preferable to easily acquire data on such outfits.

An object of the present disclosure is to provide a technology that can easily acquire clothing information of actual peoples.

In order to address such a shortcoming, one aspect of the present disclosure is a clothing information acquisition system including an acquisition unit that acquires a captured image obtained by capturing an image of the outside of a vehicle by an in-vehicle camera and location information on a location at which the image is captured, a specifying unit that specifies clothing information of a person included in the captured image, and a storage unit that stores the specified clothing information in association with the location information.

Another aspect of the present disclosure is a clothing information acquisition method. The clothing information acquisition method includes a step of acquiring a captured image obtained by capturing an image of the outside of a vehicle by an in-vehicle camera and location information on a location at which the image is captured, a step of specifying clothing information of a person included in the captured image, and a step of storing the specified clothing information in association with the location information.

With the present disclosure, it is possible to provide a technology that can easily acquire clothing information of actual peoples.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a diagram showing a clothing information acquisition system according to an embodiment and is a diagram showing an image displayed on a portable terminal device;

FIG. 2 is a diagram showing an outline of the clothing information acquisition system;

FIG. 3 is a diagram showing a functional configuration of the clothing information acquisition system;

FIG. 4 is a flowchart of processing of acquiring clothing information; and

FIG. 5 is a diagram showing a functional configuration of a clothing information acquisition system according to a modified example.

### DETAILED DESCRIPTION OF EMBODIMENTS

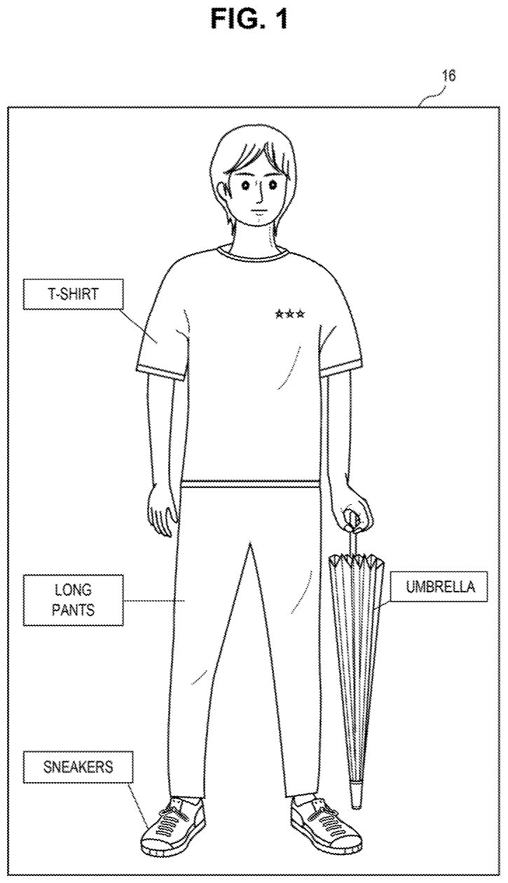

FIG. 1 is a diagram showing a clothing information acquisition system according to an embodiment and is a diagram showing an image displayed on a portable terminal device 16. FIG. 1 shows a situation in which the clothing information acquisition system of the embodiment outputs outfit coordination information to the portable terminal device 16 of the user, and the portable terminal device 16 displays the outfit coordination information to the user.

For example, when the user goes on a trip, he/she may wonder what to wear during the trip. The clothing information acquisition system according to the embodiment can suggest, to the user, the outfit coordination information according to the user's destination and can notify the user as to the style of the peoples who live at the destination of the user, and as to outfits suitable for the weather of the destination.

The portable terminal device 16 is owned by the user and has an application program for receiving the outfit coordination information. When the user inputs the destination and the date and time to the portable terminal device 16, the portable terminal device 16 displays the outfit coordination information for the destination and the date and time as shown in FIG. 1.

In FIG. 1, an image in which outfits and accessories are added to a character image is displayed. A character is wearing T-shirts, long pants and sneakers, and is holding an umbrella. The user sees the outfit coordination information and recognizes that he/she can dress lightly, comfortable shoes suitable for walking are recommended, and an umbrella is required.

When an item “T-shirt” displayed on the portable terminal device 16 is touched, the portable terminal device 16 may display a reason why “T-shirt” is suggested, for example, “a T-shirt is suitable because it is hot even at night”. Furthermore, when an item “sneakers” is touched, the portable terminal device 16 may display a reason why “sneakers” are suggested, for example, “if you go to tourist facilities at your travel destination, you should wear sneakers rather than sandals”. When an item “umbrella” is touched, “the chance of rain today is 50%” is displayed as the reason why “umbrella” is suggested. Consequently, the clothing information acquisition system can provide the user with information on suitable outfits according to the destination.

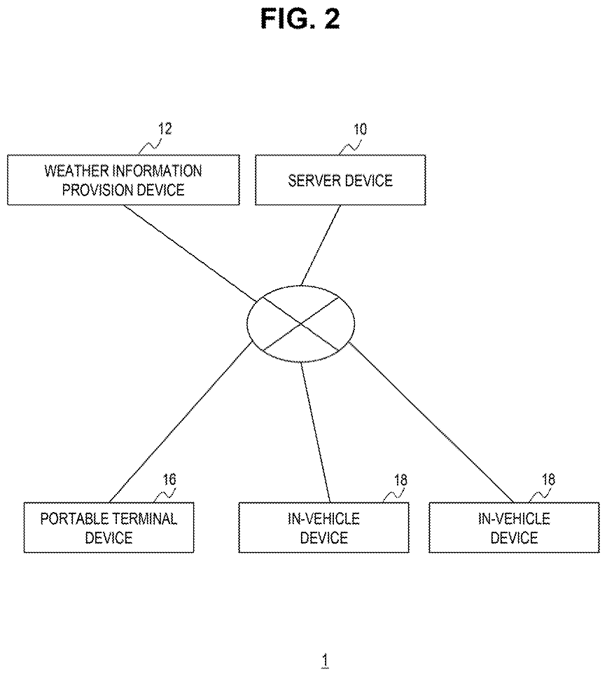

FIG. 2 is a diagram showing an outline of the clothing information acquisition system 1. The clothing information acquisition system 1 includes a server device 10, a weather information provision device 12, the portable terminal device 16, and an in-vehicle device 18. These devices can communicate via a network, such as the Internet.

The server device 10 is installed in a data center, collects captured images from the in-vehicle device 18 mounted on the vehicle, analyzes the captured images, and outputs information to the portable terminal device 16. The server device 10 functions as a clothing information acquisition device that acquires the captured images from the in-vehicle device 18, analyzes the captured images, and acquires the clothing information.

The weather information provision device 12 provides weather information to the server device 10. The weather information provision device 12 generates an estimated value of the chance of rain in each area as the weather information based on the status of rain clouds acquired from rain cloud radars provided all over the country, and provides the weather information to the server device 10. The weather information may include not only the chance of rain for each area, but also temperature, ultraviolet ray intensity, disaster information, and the like.

The in-vehicle device 18 is provided in the vehicle, and transmits the captured image obtained by capturing an image of the outside of the vehicle by an in-vehicle camera, vehicle location information, and vehicle state information to the server device 10 with a vehicle ID. For example, the in-vehicle device 18 may collectively transmit, to the server device 10, a series of captured images recorded in a drive recorder at a predetermined timing. The captured image and the vehicle location information are time-stamped, and the vehicle location information is used as location information on a location at which the image is captured and is associated with the captured image by the time stamp. The vehicle state information is the detection result of in-vehicle sensors, such as a vehicle speed sensor, an inclination sensor, and a raindrop sensor, and is information on a vehicle state. The number of in-vehicle devices 18 is not limited to two, and the clothing information acquisition system 1 may be configured such that a large number of in-vehicle devices 18 transmit the captured images and the location information to the server device 10. Accordingly, the images captured in various areas are collected in the server device 10.

The portable terminal device 16 transmits the destination information input by the user to the server device 10 and displays the outfit coordination information received from the server device 10.

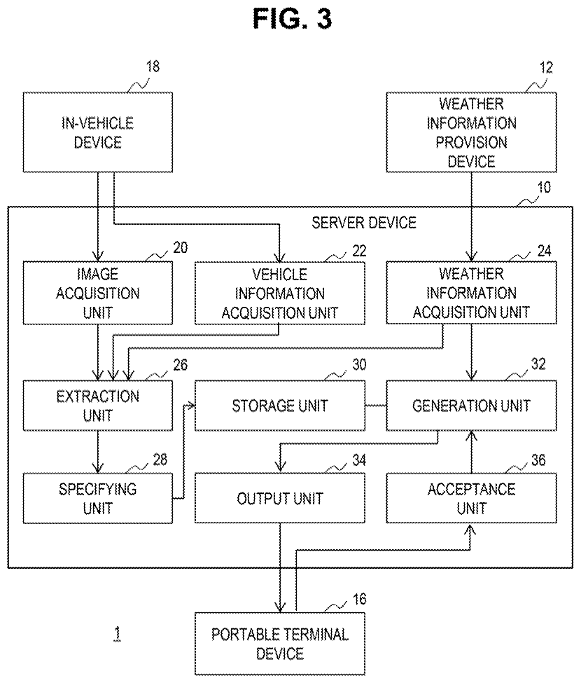

FIG. 3 is a diagram showing a functional configuration of the clothing information acquisition system 1. In FIG. 3, each component stated as a functional block for performing various processing can be configured by a circuit block, a memory, and other LSIs in terms of hardware, or can be configured by a program loaded into the memory in terms of software. Therefore, it will be apparent to those skilled in the art that those functional blocks can be implemented in various forms by hardware only, software only, or a combination thereof, but not limited to any one of them.

The server device 10 includes an image acquisition unit 20, a vehicle information acquisition unit 22, a weather information acquisition unit 24, an extraction unit 26, a specifying unit 28, a storage unit 30, a generation unit 32, an output unit 34, and an acceptance unit 36.

The acceptance unit 36 acquires the destination information and the scheduled date and time of the user from the portable terminal device 16. For example, when the user inputs the destination and the date and time to the portable terminal device 16, the destination information is transmitted to the server device 10, and the acceptance unit 36 accepts the destination information. The acceptance unit 36 preliminarily accepts attribute information (profile information), such as gender, age, and height of the user from the portable terminal device 16 and stores such information in the server device 10. The attribute information of the user is transmitted to the generation unit 32. The user's attribute information may include the user's preference information. When the acceptance unit 36 accepts the destination information from the user, processing of generating the user's outfit coordination information is started.

The image acquisition unit 20 acquires the captured image and the location information on a location at which the image is captured, which are transmitted from the in-vehicle device 18. The acquired captured image and location information on a location at which the image is captured are transmitted to the extraction unit 26. The image acquisition unit 20 may acquire the captured image and the information on the location at which the image is captured from a fixed camera provided in the facility. The image acquisition unit 20 acquires all captured images obtained by capturing by the in-vehicle camera from the in-vehicle device 18.

The vehicle information acquisition unit 22 acquires, from the in-vehicle device 18, the vehicle state information when the image is captured by the in-vehicle camera. The vehicle state information is time-stamped, and is associated, by the time stamp, with the captured image acquired by the image acquisition unit 20. The vehicle state information and the captured image may be acquired at different timings. The vehicle state information includes the vehicle speed information detected by the vehicle speed sensor, the vehicle inclination information detected by the inclination sensor, and the amount of rain falling on the vehicle detected by the raindrop sensor. The vehicle state information is used for extraction by the extraction unit 26.

The weather information acquisition unit 24 acquires the weather information from the weather information provision device 12. The weather information acquisition unit 24 acquires the weather information of the area indicated by the location at which the image is captured, and the weather information of the area indicated by the destination information. The image acquisition unit 20, the vehicle information acquisition unit 22, and the weather information acquisition unit 24 function as the acquisition unit.

The extraction unit 26 extracts the captured image in which the clothing information is to be specified by the specifying unit 28. In a case where the all of the image captured at the vehicle are transmitted to the server device 10, the image analysis processing for all captured images requires a large load and high cost. Therefore, the extraction unit 26 extracts the captured image from which the clothing information can be easily specified, based on the vehicle state information. Consequently, it is possible to reduce the load of image analysis processing.

The specifying unit 28 specifies the clothing information of the person included in the captured image obtained by capturing an image of the outside of the vehicle by the in-vehicle camera, using the image analysis processing. The specifying unit 28 extracts an image of a person from the captured image by an algorithm, such as pattern matching, analyzes the image of a person, and specifies the clothing information. The specifying unit 28 specifies the attribute information of the image of a person by image analysis and associates the attribute information with the clothing information. The attribute information of the image of a person includes gender, age, and the like. The clothing information may be kinds of clothing, for example, in a case of upper garments, a T-shirt, a long-sleeved shirt, a down coat, or the like. The clothing information is derived for each position of the outfit on the body, such as upper garments worn on the upper body, lower garments worn on the lower body, shoes, hat, gloves, sunglasses, or the like.

For example, the specifying unit 28 may specify as the clothing information for each position on the body, that the user wears a T-shirt as the upper garment, shorts as the lower garment, sandals for shoes and a cap for the type of hat, and does not wear gloves or sunglasses. The location information on a location at which the image is captured is attached to the captured image, and the specified clothing information is stored in association with the location information. The location information associated with the clothing information may be information indicated by the latitude and longitude, or may be area identification information set for each area. In any case, the clothing information specified by the specifying unit 28 can be retrieved based on the destination information of the user. Further, the specifying unit 28 may learn processing of extracting the image of a person and processing of identifying the clothing information using a neural network algorithm, and may execute the processing using the learning results.

The storage unit 30 stores the specified clothing information in association with the location information. Accordingly, the clothing information according to the area can be collected by storing the outfits of actual pedestrians in association with the location of the pedestrians. Suitable clothing information can be provided to the people traveling to such an area. In addition, it is possible to easily acquire the clothing information of people in various regions by collecting the captured images from each vehicle.

The specifying unit 28 specifies the clothing information of the person included in the captured image extracted by the extraction unit 26. Consequently, it is possible to reduce the number of captured images to be specified by the specifying unit 28. Extraction processing by the extraction unit 26 will be specifically described.

The extraction unit 26 extracts the captured image to be specified based on the vehicle speed information. The extraction unit 26 extracts a captured image obtained at a speed equal to or lower than a predetermined vehicle speed as the captured image to be specified, and excludes, from the captured images to be specified, a captured image obtained while traveling at a speed higher than the predetermined vehicle speed. When the vehicle is traveling at high speed, an afterimage is included in the image of a person in the captured image, due to which it may be difficult to specify the clothing information. Therefore, the extraction unit 26 extracts, as the captured image to be specified, a captured image captured when the vehicle speed is equal to or lower than the predetermined vehicle speed, for example, 20 km/h or less. The specifying unit 28 specifies the clothing information of the person included in the captured image obtained by capturing at a speed equal to or lower than the predetermined vehicle speed. Consequently, the clothing information can be efficiently specified while reducing the processing load. In addition, it is possible to efficiently use the captured image obtained by capturing using an in-vehicle camera having a slow shutter speed.

The extraction unit 26 extracts the captured image to be specified based on the inclination angle of the vehicle in the pitch direction. The inclination angle of the vehicle in the pitch direction is calculated based on the detection result of a tilt sensor of the vehicle. The extraction unit 26 extracts, as the captured image to be specified, a captured image obtained when the inclination of the vehicle in the pitch direction falls within a predetermined range from a horizontal direction, and excludes, from the captured images to be specified, a captured image obtained when the inclination of the vehicle in the pitch direction falls outside the predetermined range from the horizontal direction. The specifying unit 28 specifies the clothing information of the person in the captured image captured when the inclination of the vehicle in the pitch direction is within a predetermined range from the horizontal direction. Consequently, it is possible to exclude the captured image obtained by mainly capturing sky or the ground.

The extraction unit 26 extracts the captured image to be specified based on the weather information when the image is captured. The weather information may be acquired from the weather information provision device 12 as the weather information of the area corresponding to the vehicle location, or may be acquired from the detection result of the raindrop sensor mounted on the vehicle. The extraction unit 26 extracts, as the captured image to be specified, a captured image obtained when the weather information indicates that it is a fine day, and excludes, from the captured images to be specified, a captured image obtained when the weather information indicates it is a rainy or snowy day. The specifying unit 28 specifies the clothing information of the person included in the captured image obtained when the weather information indicates that it is a fine day. Consequently, it is possible to exclude the captured images of which the image quality is low.

The extraction unit 26 extracts the captured image to be specified based on a time when the image is captured, i.e. capturing time. The capturing time is attached to the captured image as a time stamp. The extraction unit 26 extracts, as the captured image to be specified, a captured image obtained during the daytime, and excludes, from the captured images to be specified, a captured image obtained during the nighttime. Consequently, it is possible to exclude the captured images obtained at night.

The extraction unit 26 extracts, at a predetermined time interval, a captured image to be specified from a series of captured images arranged in time series. For example, the extraction unit 26 extracts a captured image to be specified from the series of captured images at 1 second intervals. Consequently, it is possible to exclude the captured images that are adjacent in time series. This is because the captured images that are adjacent in time series are likely to capture the same person, and thus an duplicated analysis can be avoided.

When the generation unit 32 receives the destination information from the acceptance unit 36, the generation unit 32 extracts the clothing information according to the destination information and generates clothing information based on the clothing information specified by the specifying unit 28. In addition, the generation unit 32 generates accessories information according to the destination information based on the weather information of the destination area. The generation unit 32 generates comprehensive outfit coordination information based on the generated clothing information and accessories information.

The generation unit 32 acquires the clothing information of the area indicated by the destination information from the specifying unit 28, and selects the clothing information according to the user's attribute information. When there are several pieces of clothing information for the predetermined area, the most common kind of clothing information may be selected. That is, the generation unit 32 refers to the clothing information on the upper garment in the area indicated by the destination information, and derives a T-shirt if the proportion of people wearing a T-shirt is the highest.

The generation unit 32 generates the clothing information and the accessories information based on the weather information of the area indicated by the destination information. For example, in a case where the weather information of the area indicated by the destination information shows that it is a rainy day, the generation unit 32 derives an umbrella or a raincoat as the accessories information. The generation unit 32 may generate the accessories information based on a map that associates the weather information with the accessories information. The accessories information may include outfits, such as hats and sunglasses.

The generation unit 32 generates comprehensive outfit coordination information based on the clothing information and the accessories information according to the destination information. The outfit coordination information is a combination of outfits and accessories. The outfit coordination information generated by the generation unit 32 may be an image as shown in FIG. 1, or may be text information. The outfit coordination information generated by the generation unit 32 may be several pieces of information.

The output unit 34 outputs the generated outfit coordination information to the portable terminal device 16. The portable terminal device 16 receives the outfit coordination information and displays such information to the user. Accordingly, it is possible to enable the user to provide the outfits and accessories suitable for the destination.

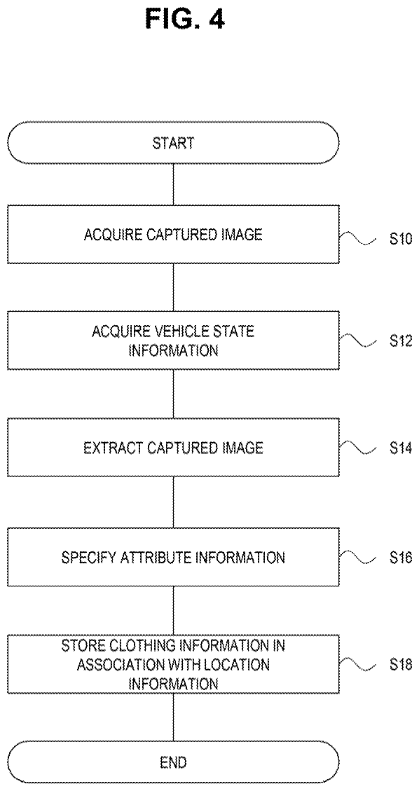

FIG. 4 is a flowchart of processing of acquiring clothing information. The image acquisition unit 20 of the server device 10 acquires the captured image and the location information on a location at which the image is captured from the in-vehicle device 18 (S10). The vehicle information acquisition unit 22 acquires the vehicle state information from the in-vehicle device 18 (S12). In addition, the weather information acquisition unit 24 acquires the weather information corresponding to the location information on a location at which the image is captured.

The extraction unit 26 extracts a captured image in which clothing information is to be specified by the specifying unit 28, based on the vehicle state information and/or the weather information (S14). Consequently, it is possible to efficiently acquire the clothing information while reducing the load of the image analysis.

The specifying unit 28 specifies the clothing information of the person included in the captured image extracted by the extraction unit 26 (S16). The storage unit 30 stores the clothing information, which is specified by the specifying unit 28, in association with the location information (S18). Consequently, it is possible to retrieve the clothing information according to the user's destination.

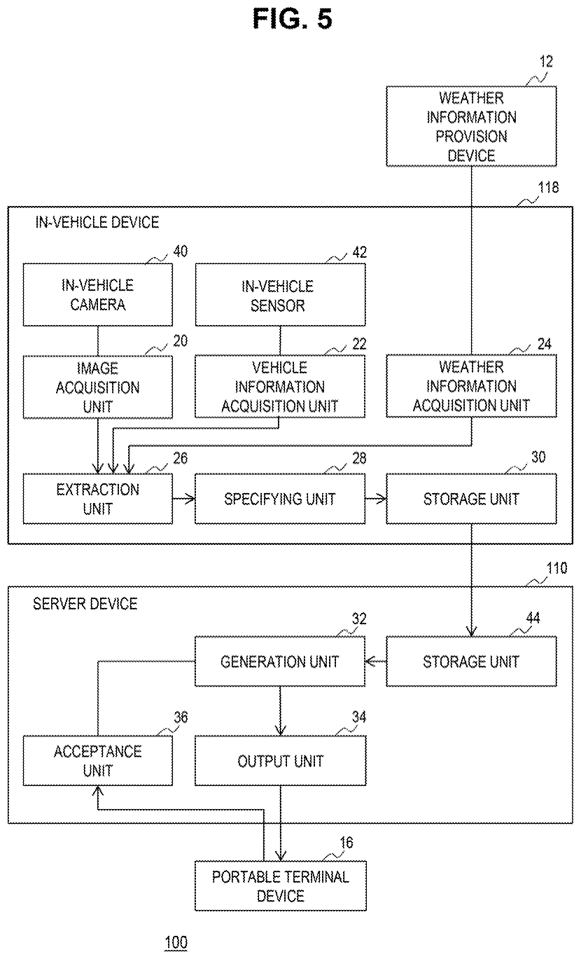

FIG. 5 is a diagram showing a functional configuration of a clothing information acquisition system 100 according to a modified example. In the clothing information acquisition system 100 of the modified example, an in-vehicle device 118 executes the image analysis processing of specifying the clothing information.

The in-vehicle device 118 includes the in-vehicle camera 40, an in-vehicle sensor 42, the image acquisition unit 20, the vehicle information acquisition unit 22, the weather information acquisition unit 24, the extraction unit 26, the specifying unit 28, and the storage unit 30. The in-vehicle camera 40 captures an image of the outside of the vehicle and transmits the captured image to the image acquisition unit 20. The captured image includes a pedestrian walking on a sidewalk or a crosswalk. The in-vehicle sensor 42 includes a vehicle speed sensor, an inclination sensor, a raindrop sensor, and the like.

Configurations of the image acquisition unit 20, the vehicle information acquisition unit 22, the weather information acquisition unit 24, the extraction unit 26, the specifying unit 28 and the storage unit 30 are the same as those of the server device 10 shown in FIG. 3. The specifying unit 28 may use the personal information on the captured image detected in obstacle collision avoidance processing. In this configuration, the in-vehicle device 118 functions as the clothing information acquisition device. The clothing information stored in the storage unit 30 is transmitted to a server device 110 at a predetermined timing, for example, when the ignition switch is turned off. Consequently, the communication load can be reduced as compared with a case where all captured images are transmitted to the server device 10.

The server device 110 includes the generation unit 32, the output unit 34, the acceptance unit 36, and a storage unit 44. The server device 110 collects the clothing information and the vehicle location information from each of the in-vehicle devices 118 and stores those pieces of information in the storage unit 44. Accordingly, the in-vehicle device 118 executes the processing of specifying the clothing information, and the server device 110 executes the processing of outputting the clothing information. The present disclosure is not limited to this aspect, and the in-vehicle device 118 and the server device 110 may share and execute various processing until the clothing information is output. For example, the in-vehicle device 118 may execute the processing of extracting the captured image, and the server device 110 may execute the processing of specifying the captured image. Even in this modified example, the communication load can be reduced.

The present disclosure has been described based on the embodiments. It will be apparent to those skilled in the art that the embodiments are merely examples, various modifications can be made to combinations of the components and processing, and such modifications also fall within the scope of the present disclosure.

What is claimed is:

1. A clothing information acquisition system, comprising:
an acquisition unit configured to acquire a captured image obtained by capturing an image of an outside of a vehicle by an in-vehicle camera and location information on a location at which the image is captured;
a specifying unit configured to specify clothing information of a person included in the captured image; and
a storage unit configured to store the specified clothing information in association with the location information.

2. The clothing information acquisition system according to claim 1, further comprising:
an extraction unit configured to extract a captured image in which the clothing information is to be specified by the specifying unit,
wherein the specifying unit is configured to specify clothing information of a person included in the captured image extracted by the extraction unit.

3. The clothing information acquisition system according to claim 2, wherein:
the acquisition unit is configured to acquire vehicle speed information of the vehicle when the in-vehicle camera captures the image; and
the extraction unit is configured to extract a captured image to be specified based on the vehicle speed information.

4. The clothing information acquisition system according to claim 3, wherein the extraction unit is configured to extract, as the captured image to be specified, a captured image at a predetermined vehicle speed or less.

5. The clothing information acquisition system according to claim 2, wherein:
the acquisition unit is configured to acquire inclination information of the vehicle when the in-vehicle camera captures the image; and
the extraction unit is configured to extract a captured image to be specified based on an inclination angle of the vehicle in a pitch direction.

6. The clothing information acquisition system according to claim 2, wherein:
the acquisition unit is configured to acquire weather information according to a location of the vehicle when the in-vehicle camera captures the image; and
the extraction unit is configured to extract a captured image to be specified based on the weather information when the image is captured.

7. The clothing information acquisition system according to claim 1, further comprising:
an acceptance unit configured to acquire destination information of a user;
a generation unit configured to generate outfit coordination information to be suggested to the user based on the clothing information corresponding to the destination information; and
an output unit configured to output the generated outfit coordination information.

8. A clothing information acquisition method, comprising:
acquiring a captured image obtained by capturing an image of an outside of a vehicle by an in-vehicle camera and location information on a location at which the image is captured;
specifying clothing information of a person included in the captured image; and
storing the specified clothing information in association with the location information.
